(19) United States
(12) Patent Application Publication
(10) Pub. No.: US 2023/0365894 A1
(43) Pub. Date: Nov. 16, 2023

(54) COMPOSITION FOR THE REMOVAL OF STAINS AND MALODOUR

(71) Applicant: Reckitt Benckiser Vanish B.V., Hoofddorp (NL)

(72) Inventors: Federico COMELLATO, Mira (IT); Andrea D'ISEPPI, Mira (IT); Irene FAVARO, Mira (IT); Monica LOPEZ, Mira (IT); Margherita MACINO, Mira (IT); Thiago MONTEIRO, Mira (IT); Sara QUAGGIA, Mira (IT); Claudia SORATO, Mira (IT); Dora ZAMUNER, Mira (IT)

(21) Appl. No.: 18/246,344

(22) PCT Filed: Sep. 28, 2021
(86) PCT No.: PCT/EP2021/076641

§ 371 Date: Mar. 23, 2023

(30) Foreign Application Priority Data
Sep. 29, 2020 (GB) 2015368.0

(51) Int. Cl. C11D 3/10; C11D 3/386; C11D 3/395; C11D 3/34; C11D 11/00

(52) U.S. Cl. CPC C11D 3/10; C11D 3/38609; C11D 3/3953; C11D 3/3481; C11D 11/0017

(57) ABSTRACT

The present invention relates to a composition, preferably a laundry detergent composition or a laundry additive composition, comprising at least one bleaching agent, at least one bleach activator, at least one oxygen transfer agent, and at least one protease, wherein: the composition comprises between 20 wt. % and 50 wt. % of said at least one bleaching agent, based on the total weight of the composition; and the composition comprises between 0.001 wt. % and 2 wt. % of said at least one oxygen transfer agent, based on the total weight of the composition, wherein said at last one oxygen transfer agent is selected from the group comprising 3-methyl-1,2-benzisothiazol-1,1-dioxide, 1,2,3-Benzoxathiazine, 2,2-dioxide, and combinations thereof. The invention further relates to a method of a laundering a fabric in a laundry washing machine. It also relates to the use of the composition for the removal of stains, malodour removal, and preferably whiteness improvement.

The present invention relates to a composition, for example a laundry detergent or a laundry additive, to a method of laundering a fabric in a laundry washing machine, to a method of cleaning a stain on a laundry item, and to the use of the composition for the removal of stains and/or the removal of malodour from a garment.

### BACKGROUND

Foods prepared with blends of spices containing turmeric or curry lead to stains that are impossible to remove with common laundry detergents, chlorine bleaches, existing laundry additives or any home remedies. Turmeric is a strong natural colorant containing curcumin and the additional presence of oil, fat, meat and other protein components like egg and milk make this type of stains even more complicated to clean. This means that in cuisines where curry/turmeric plays an important role, people are left with no solution and they have no choice than to cope with curry/turmeric stains residues on their garments, even after washing.

Clothing is also where germs and bacteria can grow, allowing the formation of malodour. Often laundry detergents and fragrance boosters try to overcome this issue by introducing a substantial amount of scent, for example in the form of microcapsules, that covers the undesired smells. However, once the volatile fragrance molecules leave the fabric, the unpleasant malodour will still be present, or can rebloom, over time or upon ironing.

Consumers associate desirability and wearability of a garment with characteristics such as e.g. absence of stains, good smell, elimination or reduction of bacteria, viruses and/or fungi (i.e. sanitization), and, in the case of white garments, improved whiteness. It is preferred when one or more of these characteristics are achieved in a simple way.

In particular, curry/turmeric greasy stains are hard to tackle, because these contain several components; for example: fats, proteins, colourants and odour.

Regular laundry compositions are useful for cleaning clothes, meaning that grime and dirt are removed. However, for the removal of stains, malodour removal, elimination or reduction of bacteria, viruses and/or fungi (i.e. sanitization), and, in the case of white garments, improved whiteness, additional laundry compositions need to be used.

Normally, people are required to follow long cleaning procedures, involving pre-treatment, vigorous rubbing action, or washings at high temperatures to achieve acceptable stain and malodour removal. For example, washing operations are normally performed at temperatures between 40° C. and 60° C.; and for sanitization purposes as high as 90° C.

Hence, there is a need of a composition, preferably a laundry detergent composition or a laundry additive composition, which provides removal of stains, in particular turmeric stains, removal of malodour and preferably whiteness improvement and elimination or reduction of bacteria, viruses and/or fungi (i.e. sanitization) of a garment being washed with such composition.

It is an object of the present invention to provide a composition, preferably a laundry detergent composition or a laundry additive, which provides a solution for these needs; in particular, when a garment is washed with the composition at temperatures lower than those normally used in washing operations.

It is an object of the present invention to provide a method of laundering a fabric in a laundry washing machine.

It is an object of the present invention to provide a use of a composition for the removal of stains, preferably turmeric and/or curry stains from a garment, and/or the removal of malodour from a garment and/or the reduction or elimination of bacteria, viruses and/or fungi from a garment.

### SUMMARY OF THE INVENTION

In a first aspect, the present invention relates to a composition comprising at least one bleaching agent, at least one bleach activator, at least one oxygen transfer agent, and at least one protease, wherein: the composition comprises between 20 wt. % and 50 wt. % of said at least one bleaching agent, based on the total weight of the composition; and the composition comprises between 0.001 wt. % and 2 wt. % of said at least one oxygen transfer agent, based on the total weight of the composition, wherein said at last one oxygen transfer agent is selected from the group comprising 3-methyl-1,2-benzisothiazol-1,1-dioxide, 1,2,3-Benzoxathiazine, 2,2-dioxide, and combinations thereof.

In one embodiment, said composition comprises:
between 30 wt. % and 50 wt. % of said at least one bleaching agent, based on the total weight of the composition; and/or
between 0.001 wt. % and 5 wt. % of said at least one protease, based on the total weight of the composition, preferably between 0.001 wt. % and 2.5 wt. %, more preferably between 0.001 wt. % and 1 wt. %; and/or
between 0.005 wt. % and 1.5 wt. % of said at least one oxygen transfer agent, based on the total weight of the composition, preferably between 0.01 wt. % and 1.00 wt. %, more preferably between 0.025 and 0.75 wt. %.

In another embodiment, said at least one bleaching agent comprises at least one source of active oxygen selected from the group comprising an inorganic peroxide, an organic peracid, hydrogen peroxide, and combinations thereof; preferably selected from the group comprising sodium percarbonate, ε-phthalimido-peroxy-hexanoic acid (PAP), peracetic acid, potassium peroxymonosulfate (KMPS), and combinations thereof; most preferably wherein said at least one bleaching agent comprises or consist of sodium percarbonate.

In an embodiment, said composition comprises between 0.1 wt. % and 20 wt. % of said at least one bleach activator, based on the total weight of the composition, preferably between 0.25 wt. % and 15 wt. %, more preferably between 0.5 wt. % and 10 wt. %, most preferably between 1 wt. % and 5 wt. %.

In another embodiment, said at least one bleach activator is selected from the group consisting of tetraacetylethylendiamine (TAED), acetylated triazine derivatives, acetylated glycoluriles, acylimides, acetylated phenolsulfonates, acetylated phenol carbonic acids, carbonic acid anhydrides, acetylated sugar derivatives, N-acetylated lactams, and combinations thereof; preferably said at least one bleach activator comprises or consists of tetraacetylethylendiamine (TAED).

In a preferred embodiment, said at least one oxygen transfer agent comprises or consists of 3-methyl-1,2-benzisothiazol-1,1-dioxide.

In an embodiment, said composition further comprises between 0.001 wt. % and 10 wt. % of one or more further enzymes, based on the total weight of the composition, preferably between 0.001 wt. % and 5 wt. %, more preferably between 0.001 wt. % and 2.5 wt. %, even more preferably between 0.001 wt. % and 2 wt. %, most preferably between 0.001 wt. % and 1 wt. %; wherein said one or more further enzyme are preferably selected from the group consisting of a mannanase, a lipase, an amylase, a cellulase, and combinations thereof.

In another embodiment, said composition is a laundry detergent composition or a laundry additive composition.

In another embodiment, the pH of a dilution of 1:100 at 20° C. of the composition is between 9 and 12, preferably between 9.5 and 11.5, more preferably between 10 and 11.

In a second aspect, the invention relates to a method of laundering a fabric in a laundry washing machine comprising adding a composition according to the first aspect to the washing machine and conducting the wash, wherein preferably the wash liquor is at a temperature lower than 40°, more preferably lower than 30° C., even more preferably lower than 25° C., most preferably lower than 20° C.; and wherein preferably between 0.5 g and 10 g of the composition are added to the laundry washing machine per litre of washing liquor, more preferably between 1 g and 5 g.

In a third aspect, the invention relates to a method of cleaning a stain on a laundry item comprising:
contacting the stain directly with a composition according to the first aspect before the laundry item is washed, or
adding a composition according to the first aspect directly into the drum of washing machine, or
adding a composition according to the first aspect to a bucket with water and soaking for a predetermined length of time.

In a fourth aspect, the invention relates to a use of the composition according to the first aspect in a laundry washing and/or fabric treatment operation.

In a fifth aspect, the invention relates to a use of the composition according to the first aspect for the removal of stains, preferably turmeric and/or curry stains, and/or the removal of malodour from a garment.

In a sixth aspect, the invention relates to a use of the composition according to the first aspect for the reduction or elimination of bacteria, viruses and/or fungi from a garment.

In an embodiment of the fifth or sixth aspect, the garment is made of cotton, synthetic materials or a combination thereof, preferably said synthetic material is polyester.

### Definitions

The following definitions are used in the present application.

“Ganz value/Instrumental evaluation” as used in the present application means:

whiteness degree simulated as Ganz-Griesser value as specified in the A.I.S.E. Laundry detergent testing guidelines.

“Protease” as used in the present application means: class of enzymes that catalyse the breakdown of proteins into smaller polypeptides or single amino acids.

“Amylase” as used in the present application means: class of enzymes that catalyse the hydrolysis of starch into sugars such as glucose and maltose.

“Mannanase” as used in the present application means: class of enzymes that catalyse the hydrolysis of mannose derivatives.

“Mannose” as used in the present application means: sugar monomer of the aldohexose series of carbohydrates.

“Lipase” as used in the present application means: class of enzymes that catalyse the hydrolysis of fats or lipids.

“Cellulase” as used in the present application means: class of enzymes that catalyse the cellulolysis or hydrolysis of cellulose.

“Laundry detergent composition” as used in the present application means: composition used primarily for the cleaning of garments and whose main action is the removal of grime and dirt, comprising a builder and not having lipases.

“Laundry additive composition” as used in the present application means: composition which is used for providing a specific consumer benefit, such as: removal of stains, elimination of malodour, improvement of whiteness and/or disinfection of garments. This means that the mean action of a laundry additive is not the removal or grime and dirt. Furthermore, a laundry additive is commonly used as a pre-treatment, in soaking conditions or together with a laundry detergent composition.

“Poly-cotton or Polycotton” as used in the present application means: fabric made of approximately 35 wt. % cotton and 65 wt. % polyester.

### DETAILED DESCRIPTION OF THE INVENTION

In a first aspect, the present invention relates to a composition comprising at least one bleaching agent, at least one bleach activator, at least one oxygen transfer agent, and at least one protease, wherein:
the composition comprises between 20 wt. % and 50 wt. % of said at least one bleaching agent, based on the total weight of the composition; and
the composition comprises between 0.001 wt. % and 2 wt. % of said at least one oxygen transfer agent, based on the total weight of the composition, wherein said at last one oxygen transfer agent is selected from the group comprising 3-methyl-1,2-benzisothiazol-1,1-dioxide, 1,2,3-Benzoxathiazine, 2,2-dioxide, and combinations thereof.

The present inventors have observed that the detergent compositions according to the invention provide a better stain removal, malodour removal and preferably also improved whiteness of fabrics than compositions not containing an oxygen transfer agent selected from the group comprising 3-methyl-1,2-benzisothiazol-1,1-dioxide, 1,2,3-Benzoxathiazine, 2,2-dioxide, and combinations thereof.

These oxygen transfer agents react in the washing liquor to produce oxaziridines, which are responsible for the improved stain removal.

Furthermore, the compositions according to the invention allow for the removal of stains and malodour, especially the removal of turmeric and/or curry stains, even at temperatures lower than those usually used in automatic laundry washing (30° C. or 40° C.). It is believed that by adding the oxygen transfer agent to a detergent composition comprising a bleaching agent and a bleach activator, the activation energy needed to bleach a stain is reduced; this means that, the compositions according to the invention allow for the removal of stains from the fabric at lower temperatures, for example, 15° C., and faster than a composition not containing the oxygen transfer agent.

In addition, the present inventors have observed a synergistic effect between all ingredients of the composition according to the invention, in particular between the oxygen transfer agent, the bleaching agent, the bleach activator, and the protease. This is evidenced by the combined removal of stains and malodour and optionally the whiteness improvement.

An effect that is obtained with the composition according to the invention, in particular in garments made of polyester, is improvement of whites or whitening. As previously discussed, the oxygen transfer agents in the compositions according to the invention produce oxaziridines, which have a hydrophobic nature and can interact with polyethylene terephthalate in polyesters textiles. This interaction allows for a better whitening of the textiles.

Preferably, said at least one oxygen transfer agent comprises or consists of 3-methyl-1,2-benzisothiazol-1,1-dioxide. The present inventors have observed that excellent results regarding stain removal, in particular removal of turmeric and/or curry stains, and malodour removal are obtained with this oxygen transfer agent.

The composition may comprise:
between 30 wt. % and 50 wt. % of said at least one bleaching agent, based on the total weight of the composition; and/or
between 0.001 wt. % and 5 wt. % of said at least one protease, based on the total weight of the composition, preferably between 0.001 wt. % and 2.5 wt. %, more preferably between 0.001 wt. % and 1 wt. %; and/or
between 0.005 wt. % and 1.5 wt. % of said at least one oxygen transfer agent, based on the total weight of the composition, preferably between 0.01 wt. % and 1.00 wt. %, more preferably between 0.025 and 0.75 wt. %.

In a preferred embodiment the composition comprises between 30 wt. % and 50 wt. % of said at least one bleaching agent, between 0.001 wt. % and 1 wt. % of said at least one protease, and between 0.025 wt. % and 0.75 wt. % of said at least one oxygen transfer agent, based on the total weight of the composition.

The bleaching agent is preferably selected from the group consisting of an oxygen-releasing bleaching agent, a chlorine-releasing bleaching agent and combinations of two or more thereof. The at least one bleaching agent may then comprise at least one source of active oxygen selected from the group comprising an inorganic peroxide, an organic peracid, hydrogen peroxide, and combinations thereof; preferably selected from the group comprising sodium percarbonate, ε-phthalimido-peroxy-hexanoic acid (PAP), peracetic acid, potassium peroxymonosulfate (KMPS), and combinations thereof; most preferably wherein said at least one bleaching agent comprises or consist of sodium percarbonate.

The at least one bleach activator is preferably selected from the group consisting of tetraacetylethylendiamine (TAED), acetylated triazine derivatives, acetylated glycoluriles, acylimides, acetylated phenolsulfonates, acetylated phenol carbonic acids, carbonic acid anhydrides, acetylated sugar derivatives, N-acetylated lactams, and combinations thereof; preferably said at least one bleach activator comprises or consists of tetraacetylethylendiamine (TAED).

The composition may comprise between 0.1 wt. % and 20 wt. % of said at least one bleach activator, based on the total weight of the composition, preferably between 0.25 wt. % and 15 wt. %, more preferably between 0.5 wt. % and 10 wt. %, most preferably between 1 wt. % and 5 wt. %.

The composition according to the invention comprising at last one oxygen transfer agent and at least one protease allows for the incorporation of more enzymes, which have a synergistic effect with the other elements of the composition. For example, the composition may further comprise between 0.001 wt. % and 10 wt. % of one or more further enzymes, based on the total weight of the composition, preferably between 0.001 wt. % and 5 wt. %, more preferably between 0.001 wt. % and 2.5 wt. %, even more preferably between 0.001 wt. % and 2 wt. %, most preferably between 0.001 wt. % and 1 wt. %; wherein said one or more further enzyme are preferably selected from the group consisting of a mannanase, a lipase, an amylase, a cellulase, and combinations thereof.

The compositions of the present invention may take any form, e.g. solid, liquid, gel, powder or mixtures thereof. Preferably, the compositions will be in form of a solid or a powder.

The composition is preferably a laundry detergent composition or a laundry additive composition, more preferably the composition is a laundry additive composition.

Preferably, the pH of a dilution of 1:100 at 20° C. of the composition is between 9 and 12, more preferably between 9.5 and 11.5, even more preferably between 10 and 11.

Preferably the composition further comprises a rheology modifier agent, a fragrance, a phase stabilizer, a dye, a softening agent, a chelating agent, an anti-bacterial agent, a transition metal compound, an anti-foaming agent, a preservative, one or more surfactants, one or more fillers, a dye-transfer inhibitor, an optical brightener, or combinations thereof.

The composition may comprise one or more non-ionic surfactants. The amount of said one or more non-ionic surfactants in the composition may be between 0.01 wt. % and 10 wt. %, based on the total weight of the composition, preferably between 0.05 and 5 wt. %, more preferably between 0.1 and 1.0 wt. %. Examples of non-ionic surfactants are ethoxylated alcohols and ethoxylated alkyl phenols having the formula R¹(OCH₂CH₂)ₙOH; wherein R¹ is an aliphatic hydrocarbon radicals containing between 10 and 24 carbon atoms or alkyl phenyl radicals in which the alkyl groups contain from 10 to 22 carbon atoms; and n has an average value of from 1 to 10. Preferably, the one or more non-ionic surfactants have the formula R¹(OCH₂CH₂)ₙOH; wherein R¹ is an alkyl moiety having between 10 and 24 carbon atoms, and n has an average value of from 1 to 10.

For example, when R¹ is defined as being a 012-14 moiety, it is meant an alkyl moiety having between 12 and 14 carbon atoms. For example, when R¹ is defined as being a C₁₂₋₁₆ moiety, it is meant an alkyl moiety having between 12 and 16 carbon atoms. For example, when R¹ is defined as being a C₁₃ moiety, it is meant an alkyl moiety having 13 carbon atoms.

In a preferred embodiment, the composition comprises between 0.01 wt. % and 10 wt. % of one or more non-ionic surfactants, based on the total weight of the composition, preferably between 0.05 and 5 wt. %, more preferably between 0.1 and 1.0 wt. %; wherein said one or more non-ionic surfactants have the formula R¹(OCH₂CH₂)ₙOH; wherein R¹ is an alkyl moiety having between 12 and 16 carbon atoms, and n has an average value of from 3 to 6, preferably between 4 and 5.

The composition may further comprise any conventional anionic surfactant or a mixture of them used in detergent products. These include, for example, the alkyl benzene sulfonic acids and their salts as well as alkoxylated or non-alkoxylated alkyl sulfate materials. The anionic surfactants may be present in acid form or in neutralized (e.g., salt) form. The anionic surfactants may be linear, branched, or a mixture thereof. An example of an anionic surfactant is sodium cumenesulphonate.

Examples of anionic surfactants are the alkali metal salts of C₁₀₋₁₆ alkyl benzene sulphonic acids or C₁₁₋₁₄ alkyl benzene sulphonic acids.

Another exemplary type of anionic surfactant is alkoxylated alkyl sulphate surfactants, such as ethoxylated alkyl sulphate surfactants. Such materials are also known as alkyl ether sulphates or alkyl polyethoxylate sulphates.

Alkyl ether sulphates are generally available in the form of mixtures comprising varying R′ chain lengths and varying degrees of ethoxylation. Frequently such mixtures also contain some non-ethoxylated alkyl sulphate (“AS”) materials.

In a preferred embodiment, the composition comprises:
between 0.01 wt. % and 10 wt. % of one or more non-ionic surfactants, based on the total weight of the composition, preferably between 0.05 and 5 wt. %, more preferably between 0.1 and 1.0 wt. %; wherein said one or more non-ionic surfactants have the formula R¹(OCH₂CH₂)ₙOH; wherein R¹ is an alkyl moiety having between 12 and 16 carbon atoms, and n has an average value of from 3 to 6, preferably between 4 and 5; and
between 0.01 wt. % and 10 wt. % of one or more anionic surfactants, based on the total weight of the composition, preferably between 0.05 and 7.5 wt. %, more preferably between 0.1 and 5 wt. %; wherein said one or more anionic surfactants preferably comprise a sodium salt o linear alkyl benzene sulfonate, sodium xylene sulfonate, an alcohol sulphate, an alfa olefin sulfonate, or combinations thereof.

The selection of non-ionic surfactants and anionic surfactants, in, for example, this preferred embodiment, is important for the compatibility of the composition with the high amounts of the bleaching agent, but also for controlling the foaming, detergency, flowability, and other physical and chemical properties of the composition.

The composition may optionally contain a filler. Suitable fillers include bicarbonates and carbonates of metals, such as alkali metals and alkaline earth metals. Examples include sodium carbonate, sodium bicarbonate, calcium carbonate, calcium bicarbonate, magnesium carbonate, magnesium bicarbonate and sesqui-carbonates of sodium, calcium and/or magnesium. Other examples include metal carboxy glycine and metal glycine carbonate. Chlorides, such as sodium chloride; citrates; and sulfates, such as sodium sulfate, calcium sulfate and magnesium sulfate, may also be employed.

Preferably the composition comprises at least one filler selected from the group comprising alkyl carbonate, alkyl sulfate and combinations thereof; more preferably selected from the group comprising sodium carbonate, sodium sulfate and combinations thereof.

When a filler is present, the composition may comprise between 0.1 wt. % and 80 wt. % of said at least one filler, based on the total weight of the composition, preferably between 10 wt. % and 75 wt. %, more preferably between 20 wt. % and 70 wt. %.

The composition may comprise an optical brightener, preferably selected from the group comprising stilbene, benzidine, benzothiazole, benzimidazole, benzoxazole, coumarin, pyrazoline, naphtalimide, naphtoxazole, distyryl-biphenyl, benzonitrile, benzopyrazole, including their derivatives and substituted compounds, and combinations thereof. Suitable optical brighteners include 4,4′-bis(2-sulphostyryl)diphenyl, 7-Diethylamino-4-methylcoumarin, benzoxazole, 2,2′-(1,2-ethenediyl) bis[5-methyl]including their substituted compounds, 4,4′-bis (triazine-2ylamino) stilbene-2,2′-disulphonic acid, mono (azol-2-yl) stilbene and bis (azol-2y1) stilbene; styryl derivatives of benzene and biphenyl, such as 1,4-bis (styryl) benzene, 4,4′-bis (styryl) benzene, 4,4′-bis-(styryl) biphenyl, 4,4′-bis (sulphostryryl) biphenyl sodium salt; pyrazolines such as 1,3-diphenyl-2-pyrazoline; bis (benzene-2-yl) derivatives, bis (benzoxazol-2-yl) derivatives and bis (benzimidazol-2-yl) derivatives; 2-(benzofuran-2-yl) benzimidazole; coumarins such as 4-methyl-7-hydroxy-coumarin or 4-methyl-7-diethylaminocoumarin; carbostyrils; naphthalimides; dibenzothiophene5,5-dioxide; pyrene; or pyridotriazole derivatives and combinations thereof.

When an optical brightener is present, the composition may comprise between 0.001 wt. % and 1 wt. % of at least one optical brightener, based on the total weight of the composition, preferably between 0.01 wt. % and 0.5 wt. %, more preferably between 0.05 wt. % and 0.25 wt. %.

The composition may further comprise a dye-transfer inhibitor. Preferred dye-transfer inhibitors (sometimes called dye anti-redisposition agents or soil suspending agents) include polyvinylalcohol, fatty amides, sodium carboxylmethyl cellulose, hydroxypropyl methyl cellulose, polyvinylpyrollidone, polyvinylimidazole, polyvinyloxazolidone, polyamine N-oxide polymers and copolymers or N-vinylpyrollidone and N-vinylimidazole.

When a dye-transfer inhibitor is present, the composition may comprise between 0.001 wt. % and 1 wt. % of at least one dye transfer inhibitor, based on the total weight of the composition, preferably between 0.01 wt. % and 0.75 wt. %, more preferably between 0.05 wt. % and 0.50 wt. %.

In a preferred embodiment, the composition is a laundry detergent composition or a laundry additive composition in form of a solid or a powder; which comprises:
between 30 wt. % and 50 wt. % of at least one bleaching agent, preferably comprising or consisting of sodium percarbonate;
between 0.025 wt. % and 0.75 wt. % of at least one oxygen transfer agent, preferably comprising or consisting of 3-methyl-1,2-benzisothiazol-1,1-dioxide;
between 0.001 wt. % and 1 wt. % of at least one protease;
between 1 wt. % and 5 wt. % of at least one bleach activator, preferably comprising or consisting of tetraacetylethylendiamine (TAED); and
preferably further comprising between 0.001 wt. % and 1 wt. % or one or more further enzymes, preferably selected from the group consisting of a mannanase, a lipase, an amylase, a cellulase, and combinations thereof;
based on the total weight of the composition.

In a second aspect, the invention relates to a method of laundering a fabric in a laundry washing machine comprising adding a composition according to the first aspect to the washing machine and conducting the wash, wherein preferably the wash liquor is at a temperature lower than 40°, more preferably lower than 30° C., even more preferably lower than 25° C., most preferably lower than 20° C.; and wherein preferably between 0.5 g and 10 g of the composition are added to the laundry washing machine per litre of washing liquor, more preferably between 1 g and 5 g.

In a third aspect, the invention relates to a method of cleaning a stain on a laundry item comprising:
contacting the stain directly with a composition according to the first aspect before the laundry item is washed, or
adding a composition according to the first aspect directly into the drum of washing machine, or
adding a composition according to the first aspect to a bucket with water and soaking for a predetermined length of time.

When the composition is added into the drum of the washing machine or when it is added to a bucket with water, the washing liquor may have between 0.5 g and 20 g of the composition by litre of washing liquor. For example, if the composition is added into the drum of the washing machine, the washing liquor may have between 0.5 g and 10 g of the composition per litre of washing liquor, preferably between 1 g and 5 g, even more preferably between 3 g and 5 g. If the composition is added to a bucket with water, the washing liquor may have between 0.5 g and 20 g of the composition per litre of washing liquor, preferably between 1 g and 15 g, more preferably between 5 g and 15 g.

When the composition is added to a bucket with water, soaking is performed for a predetermined length of time, which may be between 30 minutes and 2 hours, preferably between 45 minutes and 90 minutes, more preferably for about one hour.

It should be noted that the temperature of the washing liquor may be between 10° C. and 60° C., preferably between 10° C. and 45° C. The present inventors have observed that the composition according to the first aspect of the invention removes stains, in particular turmeric and/or curry stains, and malodour even at lower temperatures than those usually used in washing operation, for example at 15° C.

This means that the method according to the second or third aspect allows for the removal of stains and malodour, and preferably whiteness improvement, even at temperatures of for example 15° C. If the washing temperature is reduced, then energy consumption is also reduced.

In a fourth aspect, the invention relates to a use of the composition according to the first aspect in a laundry washing and/or fabric treatment operation.

In a fifth aspect, the invention relates to a use of the composition according to the first aspect for the removal of stains, preferably turmeric and/or curry stains, and/or the removal of malodour from a garment.

In a sixth aspect, the invention relates to a use of the composition according to the first aspect for the reduction or elimination of bacteria, viruses and/or fungi from a garment.

In a preferred embodiment of the fifth and sixth aspect, said garment is made of cotton, synthetic materials or a combination thereof, preferably wherein said synthetic material is polyester.

In a further aspect, the invention relates to the use of the composition according to the first aspect for the removal of stains, preferably turmeric and/or curry stains, the removal of malodour from a garment and the reduction of elimination of bacteria, viruses and/or fungi from a garment.

The foregoing aspects may be freely combined with any of the foregoing aspects disclosed herein.

All percentages used in this disclosure are by weight unless otherwise specified.

The present invention will now be described in relation to the following non-limiting Examples.

### EXAMPLES

Formulations

Formulations A-G as shown in Table 1 are comparative compositions not according to the invention.

TABLE 1
Comparative compositions

| | Formulation | | | | | | |
|---|---|---|---|---|---|---|---|
| Ingredient | A | B | C | D | E | F | G |
| Sodium Carbonate | 47.81 | 47.81 | 47.81 | 13.00 | 44.60 | 16.00 | 13.00 |
| Sodium Sulphate | 10.00 | 10.00 | 10.00 | 32.80 | 10.00 | 32.44 | 38.50 |
| Sodium Percarbonate | 35.00 | 35.00 | 35.00 | 45.00 | 40.00 | 45.00 | 40.00 |
| TAED (free) | 3.50 | 3.50 | 3.50 | 4.00 | 1.00 | 4.00 | 4.00 |
| Oxygen transfer agent | 0 | 0 | 0.75 | 0 | 0 | 0 | 0 |
| Non-ionic surfactant | 0.25 | 0.25 | 0.25 | 0.50 | 0.50 | 0.25 | 0.25 |
| Anionic surfactant | 2.00 | 2.00 | 2.00 | 2.50 | 2.59 | 0.80 | 2.00 |
| Protease | 0 | 0.25 | 0 | 0.30 | 0.18 | 0.20 | 0.29 |
| Mannanase | 0 | 0.15 | 0 | 0.20 | 0 | 0 | 0.15 |
| Lipase | 0 | 0.20 | 0 | 0.30 | 0 | 0.25 | 0.20 |
| Amylase | 0 | 0.064 | 0 | 0.10 | 0 | 0.064 | 0.064 |
| Cellulase | 0 | 0 | 0 | 0 | 0 | 0.10 | 0 |
| Fragrance | 0.03 | 0.03 | 0.03 | 0.30 | 0.03 | 0.27 | 0.30 |
| Citric acid | 0 | 0 | 0 | 0.50 | 0 | 0 | 0.50 |
| Optical brightener | 0 | 0 | 0 | 0 | 0.10 | 0.13 | 0 |
| Dye transfer inhibitor | 0 | 0 | 0 | 0 | 0 | 0 | 0.20 |
| Additional ingredients | q.s. | q.s. | q.s. | q.s. | q.s. | q.s. | q.s |

Oxygen transfer agent = 3-methyl-1,2-benzisothiazol-1,1-dioxide.
The amounts of enzymes in table 1 are the amounts of these as received from a supplier.
Additional ingredients such as: thickeners and fillers.

Formulations 1-5 as shown in Table 2 are compositions according to the invention.

TABLE 2
Formulations according to the invention

| | Formulation | | | | |
|---|---|---|---|---|---|
| Ingredient | 1 | 2 | 3 | 4 | 5 |
| Sodium Carbonate | 47.81 | 13.00 | 44.42 | 42.20 | 45.00 |
| Sodium Sulphate | 10.00 | 32.80 | 14.15 | 15.00 | 16.00 |
| Sodium Percarbonate | 35.00 | 45.00 | 35.00 | 38.00 | 35.00 |
| TAED (free) | 3.50 | 4.00 | 3.10 | 2.04 | 2.00 |
| Oxygen transfer agent | 0.23 | 0.05 | 0.12 | 0.05 | 0.05 |
| Non-ionic surfactant | 0.25 | 0.50 | 0.25 | 0.25 | 0.50 |
| Anionic surfactant | 2.00 | 2.50 | 2.00 | 1.00 | 0.50 |
| Citric acid | 0 | 0.50 | 0 | — | — |
| Protease | 0.25 | 0.30 | 0.20 | 0.20 | 0.19 |
| Mannanase | 0.15 | 0 | 0 | — | — |
| Lipase | 0.20 | 0 | 0 | 0.10 | — |
| Amylase | 0.064 | 0.10 | 0 | 0.064 | 0.064 |
| Cellulase | 0 | 0 | 0 | 0.10 | 0.10 |
| Dye transfer inhibitor | 0 | 0 | 0.25 | — | — |
| Optical brightener | — | 0 | 0 | 0.13 | 0.13 |
| Fragrance | 0.03 | 0.3 | 0.03 | 0.25 | — |
| Additional ingredients | q.s. | q.s. | q.s. | q.s. | q.s. |

Oxygen transfer agent = 3-methyl-1,2-benzisothiazol-1,1-dioxide.
The amounts of enzymes in table 2 are the amounts of these as received from a supplier.
Additional ingredients such as: thickeners and fillers.

Performance Tests

Removal of Stains in Soaking Conditions

Formulations in Table 1 and Table 2 were tested on technical stains supported on cotton and based on curry-containing recipes, which were washed in soaking conditions. The performance of the formulations and of a commercial detergent, i.e. Indian Surf Excel Quick Wash powder laundry detergent from Unilever, was observed and compared.

Each sample was tested using 60 g of the commercial detergent or 60 g of a formulation and following the same test conditions. This means that 12 g of commercial detergent or formulation were used by litre of washing liquor.

Soaking Test Conditions

Each sample was washed by soaking it in 5 L of a washing liquor containing the detergent or one of the formulations. The temperature of the washing liquor was 28° C., water hardness 28° f, and the pH of the washing liquor was of about 10.5. After 1 h soaking in the washing liquor, the samples were rinsed under tap water and dried in a tumble drier, followed by spectrophotometric instrumental evaluation.

Stain removal was determined using a Datacolor 650 spectrophotometer and by measuring the Y-value of the technical stain after washing. A higher Y-value represents a better stain removal.

The results of these tests are shown in Table 3.

List of technical stains used to study the stain removal performance:
Curry with oil—CFT CH064
Curry Chicken Bhuma—CFT CH193
Sambal Badjack—CFT CH205
Curry Vidaloo—CFT CH206
Curry Rice milk—CFT CH230
Curry Egg Masala—CFT CH261
Turmeric with oil—CFT CH208
Curry—CFT CS34
Curry— WFK 10U

TABLE 3
Removal of different technical stains supported on cotton

Y - values

Formulation

| Stain name | Detergent | A | B | C | 1 |
|---|---|---|---|---|---|
| Curry with oil | 67 | 68 | 79 | 82 | 87 |
| Curry Vidaloo | 49 | 54 | 63 | 63 | 66 |
| Curry Rice milk | 76 | 46 | 84 | 88 | 89 |
| Turmeric with oil | 71 | 75 | 83 | 88 | 89 |
| Curry - CFT CS34 | 74 | 75 | 78 | 83 | 85 |

(Each value in table 3 is the average of three measurements)

In Table 3, it is shown that a formulation according to the invention provides a better removal of turmeric and curry stains than the detergent and the comparative formulations.

Removal of Stains at Lower Temperatures in Washing Machine

Technical stains supported on cotton were washed in a laundry washing machine in a washing liquor containing one of the detergent systems shown in Table 4 at 15° C. or 30° C.

TABLE 4
Detergent systems and temperatures of washing liquor

| Detergent | | |
|---|---|---|
| system | Components | Temperature |
| Da* | 35 mL Commercial detergent | 30° C. |
| Db* | 35 mL Commercial detergent + | 30° C. |
| | 60 g Formulation D | |
| Dc* | 35 mL Commercial detergent + | 15° C. |
| | 60 g Formulation D | |
| Dd | 35 mL Commercial detergent + | 15° C. |
| | 60 g Formulation 2 | |

The commercial detergent in Table 4 is Ariel liquid as sold in the UK.

Washing Test Conditions

Each sample was washed in an AEG 7000 laundry washing machine at a temperature of 30° C. or 15° C. using a cotton cycle (duration 1 hour and 30 minutes), water hardness of 28° f.

Stain removal was determined using a Datacolor 650 spectrophotometer and by measuring the Y-value of the technical stain after washing. A higher Y-value represents a better stain removal.

The results of these tests are shown in Table 5.

TABLE 5
Removal of different technical stains supported
on cotton at different temperatures

Y - values
Detergent system

| Stain name | Da* | Db* | Dc* | Dd |
|---|---|---|---|---|
| Tomato | 81 | 83 | 83 | 83 |
| Tea | 52 | 64 | 60 | 64 |
| Curry | 76 | 80 | 78 | 81 |
| Blueberry juice | 43 | 70 | 64 | 67 |
| Expresso coffee | 49 | 66 | 59 | 64 |
| Red wine | 45 | 59 | 52 | 58 |
| Grass | 76 | 83 | 83 | 84 |
| Make up | 70 | 71 | 69 | 71 |
| Gravy | 79 | 85 | 81 | 83 |
| Barbeque sauce | 87 | 89 | 88 | 89 |
| Used cooking fat | 88 | 89 | 86 | 88 |
| Chocolate | 48 | 52 | 48 | 49 |
| Egg | 73 | 85 | 82 | 83 |
| AVERAGE | 67 | 75 | 72 | 74 |

(Each value in table 5 is the average of four measurements)

The results in table 5 demonstrate that a composition according to the invention (formulation 2) allows for the removal of stains (bleachable, greasy and enzymatic) at temperatures lower than those normally used in washing operations. In particular, it is shown that a composition according to the invention allows for the removal of curry stains.

These results show that the performance of a detergent system comprising a composition according to the invention at a temperature lower than that normally used in washing operations, i.e. lower than 30° C. or 40° C.:
is better than the performance of a detergent system comprising a comparative formulation free of oxygen transfer agent at a similar temperature;
is similar to the performance of a detergent system comprising a comparative formulation free of oxygen transfer agent at a higher temperature; and
is better than the performance of a commercial detergent at a higher temperature.

This means that, a composition according to the invention allows for the removal of stains, while reducing the energy consumption and CO₂ emissions, thanks to the lower temperatures that can be used.

Removal of Stains at Standard Temperatures in Soaking Conditions

Technical stains supported on cotton were washed in soaking conditions in a washing liquor at 30° C. and containing one of the detergent systems of Table 6.

TABLE 6
Detergent systems and temperatures of
washing liquor in soaking conditions

| Detergent | | |
|---|---|---|
| system | Components | Temperature |
| De* | 120 g Commercial detergent | 30° C. |
| Df* | 60 g Formulation E | 30° C. |
| Dg | 60 g Formulation 3 | 30° C. |

The commercial detergent in Table 6 is Surf excel powder as sold in India.

Washing Conditions—Soaking

Each sample was washed by soaking it in 5 L of a washing liquor containing one of the detergent systems of Table 6. The temperature of the washing liquor was 30° C. and water hardness 15° f. After 1 h soaking in the washing liquor, the samples were rinsed under tap water and dried in a tumble drier, followed by spectrophotometric instrumental evaluation. The amount of formulation e or 3 that was added to the washing liquor was 12 g per litre of washing liquor.

Stain removal was determined using a Datacolor 650 spectrophotometer and by measuring the Y-value of the technical stain after washing. A higher Y-value represents a better stain removal.

The results of these tests are shown in Table 7.

TABLE 7
Removal of different technical stains supported
on cotton at 30° C. in soaking conditions

| | | | Y - values | | |
|---|---|---|---|---|---|
| | | | Detergent system | | |
| | Stain Code | Stain name | De* | Df* | Dg |
| Greasy | C-H064 | curry with oil | 39.89 | 51.51 | 78.39 |
| stains | C-H193 | Curry, chicken | 79.83 | 81.26 | 85.62 |
| | | bhuma | | | |
| | C-H208 | Tumeric with oil | 40.20 | 49.44 | 86.08 |
| | C-H230 | curry, rice, milk | 46.69 | 57.03 | 83.77 |
| | C-H261 | curry, egg, masala | 67.92 | 75.83 | 83.13 |
| | WE5BBWKC | cooked beef fat | 67.93 | 69.23 | 74.36 |
| | | AVERAGE | 57.10 | 64.05 | 81.99 |
| Bleachable | C-S-08 | grass | 72.61 | 74.72 | 77.99 |
| stains | C-S-15 | blueberry juice | 40.80 | 73.52 | 77.04 |
| | W-10U | curry | 61.81 | 67.84 | 84.26 |
| | WE5ECWKC | coffee | 65.42 | 82.36 | 86.76 |
| | WE5FSMWKC | french squeeze | 43.98 | 51.56 | 66.86 |
| | | mustard | | | |
| | WE5LTWKC | tea | 33.46 | 72.98 | 75.92 |
| | WE5RWWKC | red wine | 50.17 | 80.11 | 82.74 |
| | | AVERAGE | 52.61 | 71.87 | 78.80 |
| Enzymatic | C-S-44 | chocolate drink | 36.62 | 51.89 | 57.73 |
| Stains | | pure | | | |
| | WE5DASBKC | sheep blood | 59.56 | 62.28 | 61.09 |
| | | AVERAGE | 48.10 | 57.09 | 59.41 |

(Each value in table 8 is the average of four measurements)

The results in table 7 demonstrate that a composition according to the invention (formulation 3) allows for the removal of stains (greasy, bleachable and enzymatic), in particular the removal of turmeric and curry greasy stains.

Whitening

Standard white fabrics made of polyester, cotton or mixed polyester/cotton were washed in a laundry washing machine in a washing liquor containing one of the detergent systems in a laundry washing machine containing one of the detergent systems of Table 8.

TABLE 8
Detergent systems and temperatures of washing
liquor in laundry washing machine

| Detergent | | |
|---|---|---|
| system | Components | Temperature |
| Dh* | 65 g Commercial detergent 1 + | 40° C. |
| | 60 g Formulation F | |
| Di | 65 g Commercial detergent 1 + | 40° C. |
| | 60 g Formulation 2 | |
| Dj* | 35 mL Commercial detergent 2 | 30° C. |
| Dk* | 35 mL Commercial detergent 2 + | 30° C. |
| | 60 g Formulation F | |
| Dl | 35 mL Commercial detergent 2 + | 30° C. |
| | 60 g Formulation 4 | |

In table 8 commercial detergent 1 is Ariel powder and commercial detergent 2 is Ariel gel.

Washing Test Conditions

The tested fabrics were washed up to 35 cumulative cycles in a Miele Plus 6065 laundry washing machine at a temperature of 30° C. or 40° C. using a cotton cycle, water hardness of 28° f. The amount of formulation 2, 4 or F that was added to the washing machine was of between 3.5 and 5 g of formulation per litre of washing liquor.

The whiteness performance was given using a Datacolor 650 spectrophotometer and by determining the Ganz whiteness degree. A higher Ganz whiteness degree corresponds to a better whitening performance.

The results of these tests are shown in Tables 9 and 10.

TABLE 9
Whitening of fabrics at 40° C.

| | | Ganz Value | | |
|---|---|---|---|---|
| Detergent | | After 0 | After 5 | After 35 |
| system | Fabric | washes | washes | washes |
| Dh* | 100% polyester | 72 | — | 84 |
| Di | | 72 | — | 94 |

TABLE 10
Whitening of fabrics at 30° C.

| | | Ganz Value | | |
|---|---|---|---|---|
| Detergent | | After 0 | After 5 | After 35 |
| system | Fabric | washes | washes | washes |
| Dj* | 100% cotton | 67.2 | 159.4 | 191.4 |
| Dk* | WFK 10 A | 67.2 | 189.4 | 222.8 |
| Dl | | 67.2 | 197.4 | 220.1 |
| Dj* | 65% polyester/35% | 68.2 | 130.2 | 156.4 |
| Dk* | cotton | 68.2 | 162.6 | 183.5 |
| Dl | WFK 20A | 68.2 | 162.2 | 183.5 |
| Dj* | 100% polyester | 67.4 | 72.8 | 74.3 |
| Dk* | WFK 30A | 67.4 | 77.5 | 87.4 |
| Dl | | 67.4 | 78.8 | 88.0 |
| Dj* | 100% polyester | 60.9 | 62.1 | 64.2 |
| Dk* | Decathlon t-shirt | 60.9 | 69.4 | 80.9 |
| Dl | | 60.9 | n.a. | 82.4 |
| Dj* | 100% polyester | 201.4 | 203.5 | 212.6 |
| Dk* | Colonia | 201.4 | 207.7 | 209.5 |
| Dl | | 201.4 | 208.8 | 216.6 |

The results in tables 9 and 10 demonstrate that compositions according to the invention (formulations 2 and 4) provide better whitening than a commercial detergent or detergent systems comprising a composition not according to the invention. This effect is particularly shown in fabrics comprising or consisting of a synthetic material, such as polyester.

Malodour Removal

Two mixtures of smelly molecules representative of body and foot smells, respectively, were produced. Few drops of each mixture were dropped on cotton (100% cotton) and polycotton (65% polyester, 35% cotton) fabrics producing smelly test swatches. The swatches were then washed. The odour removal was determined by gas chromatography by measuring the quantity of molecules responsible for the body and foot smell, respectively, in each fabric before and after washing and it is given as the percentage of odour removal, i.e. percentage of removal of smelly molecules. The odour removal represents the ability of a formulation to break down smelly molecules.

The molecules present in the initial mixtures and analysed by Gas Chromatography-Mass Spectrometry (GC-MS) are:

Foot smell—mixture of:
n-Decanol
Propyonic acid
Undecanale
2-Octanone

Body smell—mixture of:
Decanale
4-Ethyloctanoic acid
Undecanale
Iso Valerianic Acid
Butyric acid
Trans-2-nonenal

Fabrics with the smelly mixtures were washed either by soaking or in a laundry machine in a washing liquor containing one of the detergent systems shown in Table 11.

TABLE 11
Detergent systems and temperatures of washing liquor
in soaking and in laundry washing machine

| Detergent | | |
|---|---|---|
| system | Components | Temperature |
| Dm* | 35 mL Commercial detergent | 30° C. |
| Dn | 60 g Formulation 1 - soaking conditions | 28° C. |
| Do* | 35 mL Commercial detergent + | 30° C. |
| | 60 g Formulation D | |
| Dp | 35 mL Commercial detergent + | 30° C. |
| | 60 g Formulation 5 | |
| Dq* | 60 g Formulation D | 40° C. |
| Dr | 60 g Formulation 5 | 40° C. |

The commercial detergent in Table 11 is Ariel liquid as sold in the UK.

Soaking Test Conditions

Each sample was washed by soaking it in a washing liquor (5 L of washing liquor for detergent system Du and 4 L of washing liquor for detergent systems Dq* and Dr) containing the detergent system of table 11. The temperature of the washing liquor was 28° C. or 40° C. After 1 h soaking in the washing liquor, the samples were rinsed under tap water and dried in a tumble drier, followed by instrumental evaluation by gas chromatography.

Washing Test Conditions

Each sample was washed in a laundry washing machine at a temperature of 30° C. and using a cotton cycle.

TABLE 12
Malodour removal from a garment

| Detergent | | | | % odour |
|---|---|---|---|---|
| system | Fabric | Smell | Condition | removal |
| Dm* | Cotton | Body | Washing machine | 94.9 |
| Dm* | Cotton | Foot | Washing machine | 72.7 |
| Dm* | Polycotton | Body | Washing machine | 95.7 |
| Dm* | Polycotton | Foot | Washing machine | 92.2 |
| Dn | Cotton | Body | Soaking | 97.5 |
| Dn | Cotton | Foot | Soaking | 93.1 |
| Dn | Polycotton | Body | Soaking | 98.5 |
| Dn | Polycotton | Foot | Soaking | 98.2 |
| Do* | Cotton | Foot | Washing machine | 92 |
| Do* | Polycotton | Foot | Washing machine | 91 |
| Dp | Cotton | Foot | Washing machine | 94 |
| Dp | Polycotton | Foot | Washing machine | 96 |
| Dq* | Cotton | Body | Soaking | 99 |
| Dq* | Polycotton | Boy | Soaking | 96 |
| Dr | Cotton | Body | Soaking | 98 |
| Dr | PolyCotton | Body | Soaking | 99 |

The results in table 12 demonstrate that the compositions according to the invention (formulations 1 and 5) provide a better malodour removal than the commercial detergent or detergent systems comprising a composition not according to the invention.

These results show that the composition according to the invention provides:
removal of stains, especially turmeric and curry greasy stains,
malodour removal; and
preferably also whiteness improvement in a garment.

Hence one or more objects of the present invention are achieved by the present which is further elucidated in the appended claims.

1. A composition comprising:
between 20 wt. % and 50 wt. % of at least one bleaching agent based on the total weight of the composition;
at least one bleach activator;
between 0.001 wt. % and 2 wt. % of at least one oxygen transfer agent based on the total weight of the composition; and
at least one protease,
wherein
the at last one oxygen transfer agent is selected from the group comprising 3-methyl-1,2-benzisothiazol-1,1-dioxide, 1,2,3-Benzoxathiazine, 2,2-dioxide, and combinations thereof.

2. The composition according to claim 1, wherein the composition comprises:
between 30 wt. % and 50 wt. % of the at least one bleaching agent, based on the total weight of the composition; and/or
between 0.001 wt. % and 5 wt. % of the at least one protease, based on the total weight of the composition; and/or
between 0.005 wt. % and 1.5 wt. % of the at least one oxygen transfer agent, based on the total weight of the composition.

3. The composition according to claim 1, wherein the at least one bleaching agent comprises at least one source of active oxygen selected from the group consisting of an inorganic peroxide, an organic peracid, hydrogen peroxide, and combinations thereof.

4. The composition according to claim 1, wherein the composition comprises between 0.1 wt. % and 20 wt. % of the at least one bleach activator, based on the total weight of the composition.

5. The composition according to claim 1, wherein the at least one bleach activator is selected from the group consisting of tetraacetylethylendiamine (TAED), acetylated triazine derivatives, acetylated glycoluriles, acylimides, acetylated phenolsulfonates, acetylated phenol carbonic acids, carbonic acid anhydrides, acetylated sugar derivatives, N-acetylated lactams, and combinations thereof.

6. The composition according to claim 1, wherein the at least one oxygen transfer agent comprises or consists of 3-methyl-1,2-benzisothiazol-1,1-dioxide.

7. The composition according to claim 1, wherein the composition further comprises between 0.001 wt. % and 10 wt. % of one or more further enzymes, based on the total weight of the composition, wherein the one or more further enzymes are selected from the group consisting of a mannanase, a lipase, an amylase, a cellulase, and combinations thereof.

8. The composition according to claim 1, wherein the composition is a laundry detergent composition or a laundry additive composition.

9. The composition according to claim 1, wherein a pH of a dilution of 1:100 at 20° C. of the composition is between 9 and 12.

10. The composition according to claim 1, wherein the composition is in form of a solid or a powder.

11. A method of laundering a fabric in a laundry washing machine comprising:
adding the composition according to claim 1 to the washing machine; and
conducting a wash, wherein a wash liquor is at a temperature higher than 15° C. and lower than 40°, and
wherein between 0.5 g and 10 g of the composition are added to the laundry washing machine per litre of washing liquor.

12. A method of cleaning a stain on a laundry item, the method comprising:
contacting the stain directly with the composition according to claim 1 before the laundry item is washed, or
adding the composition according to claim 1 directly into a drum of a washing machine, or
adding the composition according to claim 1 to a bucket with water and soaking for a predetermined length of time.

13. A method of using the composition according to claim 1 in a laundry washing and/or fabric treatment operation.

14. A method of using the composition according to claim 1 for the removal of stains, and/or the removal of malodour from a garment.

15. A method of using the composition according to claim 1 for the reduction or elimination of bacteria, viruses and/or fungi from a garment.

16. A method of using according to claim 14 or to claim 15, wherein said garment is made of cotton, synthetic materials or a combination thereof.

17. The composition according to claim 2, wherein the composition comprises between 0.01 wt. % and 1.00 wt. % of the at least one oxygen transfer agent.

18. The composition according to claim 2, wherein the composition comprises between 0.025 and 0.75 wt. % of the at least one oxygen transfer agent.

19. The composition according to claim 3, wherein the at least one bleaching agent comprises at least one source of active oxygen selected from the group consisting of sodium percarbonate, ε-phthalimido-peroxy-hexanoic acid (PAP), peracetic acid, potassium peroxymonosulfate (KMPS), and combinations thereof.

20. The composition according to claim 3, wherein the at least one bleaching agent comprises or consists of sodium percarbonate.
